(19) United States
(12) Patent Application Publication
(10) Pub. No.: US 2025/0092578 A1
(43) Pub. Date: Mar. 20, 2025

(54) PLA FIBRES AND NONWOVENS MADE THEREOF

(71) Applicants: TOTALENERGIES CORBION BV, Gorinchem (NL); SUZHOU KINGCHARM NEW MATERIALS CORP, Changshu City, Jiangsu Province (CN)

(72) Inventors: Gerrit GOBIUS DU SART, Herwijnen (NL); Zhou YUXIANG, Shanghai (CN); Li WENJUN, Changshu City (CN); Fan HAIBIN, Changshu City (CN); Sun ZHOUYU, Changshu City (CN)

(73) Assignees: TOTALENERGIES CORBION BV, Gorinchem (NL); SUZHOU KINGCHARM NEW MATERIALS CORP, Changshu City, Jiangsu Province (CN)

(21) Appl. No.: 18/729,294

(22) PCT Filed: Jan. 27, 2023
(86) PCT No.: PCT/IB2023/050703

§ 371 Date: Jul. 16, 2024

(30) Foreign Application Priority Data
Jan. 27, 2022 (CN) 202210099541.9
Jan. 27, 2022 (EP) 22153703.8

(51) Int. Cl. D01F 6/92; D01F 1/10; D01F 6/62; D04H 1/435; D04H 1/541; D04H 1/55; D04H 1/724

(52) U.S. Cl. CPC D01F 6/92; D01F 1/10; D01F 6/625; D04H 1/435; D04H 1/5418; D04H 1/55; D04H 1/724; D10B 2331/04; D10B 2509/00

(57) ABSTRACT

The present invention relates to fibres comprising a polymer composition. The invention also relates to non-wovens comprising the fibres, articles made therefrom, a process for producing said fibres, and a process for producing non wovens. The present invention also relates to the use of a blend as softening agent for PLA polymer fibres, and non-wovens. The invention also relates to the use of a non-woven as a contact layer, dispersion layer or an absorbing layer in an article.

### FIELD OF THE INVENTION

The present invention relates to the technical field of fibres and non-wovens. The present invention relates more in particular to biodegradable fibres and non-wovens, which comprise polylactide polymers.

### BACKGROUND OF THE INVENTION

Due to the transition towards the use of biodegradable polymers, there has been a great interest to replace commonly used non-biodegradable polymers with polylactide (PLA) polymers. However, often, when making such a replacement, polylactide polymers are inferior in some key properties for certain applications. For example, for fibres and non-wovens made from poly-lactide polymers, the softness is inferior to fibres and non-wovens made from polyolefins. There have been solutions proposed in the art to increase the softness of fibres made from polylactide polymer. However, these solutions have drawback on some other key parameters, such as tenacity or crimp elasticity.

Hence, there remains a demand to provide polylactide based fibres and/or non-wovens with improved organoleptic properties, preferably in a combination with a high tenacity. There is a demand for polylactide based fibres and/or non-wovens to be soft to the touch. There is also a demand for polylactide based fibres and/or non-wovens to have a high crimp elasticity. There is a demand for polylactide based fibres and/or non-wovens to feel smooth. There is a demand for polylactide based fibres and/or non-wovens to be easily deformable. There is a demand for polylactide based fibres and/or non-wovens to feel voluminously and/or bulky. There is a demand for all the polymers in the polylactide based fibres and/or non-wovens to be biodegradable polymers.

### SUMMARY OF THE INVENTION

It has now surprisingly been found that some or all of the above demands and objectives can be attained either individually or in any combination by fibres and non-wovens comprising a polymer composition as defined herein.

In particular, in a first aspect, the present invention provides fibres, comprising a polymer composition, wherein said polymer composition comprises, relative to the total weight of the polymer composition:
from at least 70.0% by weight to at most 97.5% by weight of a polylactide (PLA) polymer;
from at least 1.0% by weight to at most 10.0% by weight of a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
from at least 1.0% by weight to at most 10.0% by weight of a second polymer, selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and
from at least 0.5% by weight to at most 10.0% by weight of a fatty acid bisamide or an alkyl-substituted fatty acid monoamide.

In second aspect, the present invention provides a non-woven, comprising the fibres according to any of the embodiments/aspects described herein.

In third aspect, the present invention provides the use of a blend as softening agent for polylactide (PLA) polymer fibres, wherein the blend comprises:
a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and,
a fatty acid bisamide or an alkyl-substituted fatty acid monoamide.

In another aspect, the present invention provides the use of a blend as softening agent for polylactide (PLA) polymer non-wovens, wherein the blend comprises:
a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and,
a fatty acid bisamide or an alkyl-substituted fatty acid monoamide.

In another aspect, the present invention provides a process for producing fibres, preferably fibres according to any of the embodiments/aspects described herein, comprising the steps of:
a) providing a polymer composition comprising:
   from at least 70.0% by weight to at most 97.5% by weight polylactide (PLA) polymer;
   from at least 1.0% by weight to at most 10.0% by weight of a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
   from at least 1.0% by weight to at most 10.0% by weight of a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC), wherein said first and second polymers are selected such as not to be the same; and
   from at least 0.5% by weight to at most 10.0% by weight of a fatty acid bisamide or an alkyl-substituted fatty acid monoamide;
b) processing the polymer composition into fibres.

In another aspect, the present invention provides a process for producing non-wovens comprising the steps of:
arranging fibres obtained in an embodiment described herein, in a web or in two or more cross-lapped webs; and,
consolidating of the web(s).

In another aspect, the present invention provides an article comprising a non-woven according to any one of the embodiments/aspects described herein or produced by a process according to any one of the embodiments/aspects described herein, preferably wherein the article is a garment, a mask, a wipe or a hygiene product.

In another aspect, the present invention provides the use of a non-woven according to any one of the embodiments/aspects described herein, or produced by a process according to any one of the embodiments/aspects described herein, as a contact layer, dispersion layer or an absorbing layer in an article, preferably a hygiene product.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature or statement indicated as being preferred or advantageous may be combined with any other features or statements indicated as being preferred or advantageous.

### DETAILED DESCRIPTION OF THE INVENTION

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims and statements, any one of the embodiments can be used in any combination.

The terms “comprising”, “comprises” and “comprised of” as used herein are synonymous with “including”, “includes” or “containing”, “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

As used in the specification and the appended claims, the singular forms “a”, “an,” and “the” include plural referents unless the context clearly dictates otherwise. By way of example, “a step” means one step or more than one step.

Unless defined otherwise, all technical and scientific terms used herein have the same meaning as is commonly understood by one of skill in the art.

The recitation of numerical ranges by endpoints includes all integer numbers and, where appropriate, fractions subsumed within that range (e.g., 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g., from 1.0 to 5.0 includes both 1.0 and 5.0). Any numerical range recited herein is intended to include all sub-ranges subsumed therein.

The term “about” as used herein when referring to a measurable value such as a parameter, an amount, a temporal duration, and the like, is meant to encompass variations of +/−10% or less, preferably +/−5% or less, more preferably +/−1% or less, of and from the specified value, insofar such variations are appropriate to perform in the disclosed invention. It is to be understood that the value to which the modifier “about” refers is itself also specifically, and preferably, disclosed.

The terms “wt %”, “vol %”, or “mol %” refers to a weight percentage of a component, a volume percentage of a component, or molar percentage of a component, respectively, based on the total weight, the total volume of material, or total moles, that includes the component.

When describing the present invention, the terms used are to be construed in accordance with the following definitions, unless a context dictates otherwise.

Preferred statements (features) and embodiments and uses of this invention are set herein below. Each statement and embodiment of the invention so defined may be combined with any other statement and/or embodiment unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered statements and embodiments, with any other aspect and/or embodiment.
1. Fibres, comprising a polymer composition, wherein said polymer composition comprises, relative to the total weight of the polymer composition:
   from at least 70.0% by weight to at most 97.5% by weight of a polylactide (PLA) polymer;
   from at least 1.0% by weight to at most 10.0% by weight of a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
   from at least 1.0% by weight to at most 10.0% by weight of a second polymer, selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and
   from at least 0.5% by weight to at most 10.0% by weight of a fatty acid bisamide or an alkyl-substituted fatty acid monoamide.
2. Fibres according to statement 1, wherein the first polymer is selected from the group comprising polybutylene succinate (PBS), poly(ethylene succinate) (PES), poly(propylene succinate) (PPS), polybutylene adipate (PBA), polybutylene succinate adipate (PBSA), and polybutylene succinate terephthalate (PBST); preferably PBS.
3. Fibres according to any one of statements 1 or 2, wherein the second polymer is selected from the group comprising polybutylene adipate terephthalate (PBAT), polycaprolactone (PCL), polyhydroxyalkanoates (PHA), and polypropylene carbonate (PPC); preferably PBAT.
4. Fibres according to any one of the previous statements, wherein the polymer composition comprises, relative to the total weight of the polymer composition:
   from at least 70.0% by weight to at most 97.5% by weight of a polylactide (PLA) polymer;
   from at least 1.0% by weight to at most 10.0% by weight of a first polymer selected from the group comprising polybutylene succinate (PBS), poly(ethylene succinate) (PES), poly(propylene succinate) (PPS), polybutylene adipate (PBA), and polybutylene succinate adipate (PBSA), polybutylene succinate terephthalate (PBST);
   from at least 1.0% by weight to at most 10.0% by weight of a second polymer, selected from the group comprising polybutylene adipate terephthalate (PBAT), polycaprolactone (PCL), polyhydroxyalkanoates (PHA), and polypropylene carbonate (PPC); and
   from at least 0.5% by weight to at most 10.0% by weight of a fatty acid bisamide or an alkyl-substituted fatty acid monoamide.
5. Fibres according to any one of the previous statements, wherein the polymer composition comprises from at least 2.0% by weight to at most 10.0% by weight of the first polymer relative to the total weight of the composition, preferably at least 3.0% by weight to at most 9.0% by weight, preferably at least 4.0% by weight to at most 8.0% by weight, preferably at least 5.0% by weight to at most 7.0% by weight, preferably at least 5.5% by weight to at most 6.5% by weight, of the first polymer.
6. Fibres according to any one of the previous statements, wherein the first polymer is a poly(butylene succinate) (PBS).
7. Fibres according to any one of the previous statements, wherein the melt flow index of the first polymer is at least 1 g/10 min to at most 45 g/10, preferably at least 5 g/10 min to at most 40 g/10 min, preferably at least 10 g/10 min to at most 35 g/10 min according to ISO 1133-A, 2011 (190° C., 2160 g).
8. Fibres according to any one of the previous statements, wherein the melting point of the first polymer is at least 100° C. to at most 130° C., preferably at least 103° C. to at most 125° C., preferably at least 105° C. to at most 123° C., preferably at least 107° C. to at most 120° C., preferably at least 110° C. to at most 116° C., according to ISO 11357-1, 2016.
9. Fibres according to any one of the previous statements, wherein the density of the first polymer is at least 1.10 g/cm³ to at most 1.40 g/cm³, preferably at least 1.10 g/cm³ to at most 1.35 g/cm³, preferably at least 1.15 g/cm³ to at most 1.35 g/cm³, preferably at least 1.18 g/cm³ to at most 1.32 g/cm³, preferably at least 1.20 g/cm³ to at most 1.30 g/cm³, preferably at least 1.22 g/cm³ to at most 1.28 g/cm³, preferably at least 1.24 g/cm³ to at most 1.26 g/cm³, according to ISO 1183-1, 2019.
10. Fibres according to any one of the previous statements, wherein the polymer composition comprises from at least 1.0% by weight to at most 7.0% by weight of the second polymer, relative to the total weight of the polymer composition, preferably at least 1.0% by weight to at most 5.0% by weight, preferably at least 1.2% by weight to at most 4.0% by weight, preferably at least 1.5% by weight to at most 3.0% by weight, preferably at least 1.7% by weight to at most 2.5% by weight, of the second polymer.
11. Fibres according to any one of the previous statements, wherein the polyhydroxybutyrate (PHB) is selected from the group comprising poly-4-hydroxybutyrates (P4HB), poly-3-hydroxybutyrates (PHB), polyhydroxyvalerate (PHV), polyhydroxyhexanoate (PHH), polyhydroxyoctanoate (PHO) and copolymers thereof, such as e.g., poly(3-hydroxybutyrate-co-3-hydroxyvalerate (PHBV).
12. Fibres according to any one of the previous statements, wherein the second polymer is polybutylene adipate terephthalate (PBAT) or polycaprolactone (PCL).
13. Fibres according to any one of the previous statements, wherein the second polymer is poly(butylene adipate-co-terephthalate) (PBAT).
14. Fibres according to any one of the previous statements, wherein the first polymer is poly(butylene succinate) (PBS) and wherein the second polymer is poly(butylene adipate-co-terephthalate) (PBAT).
15. Fibres according to any one of the previous statements, wherein the combined weight fraction of the first polymer and the second polymer together amounts to at most 20.0% by weight, preferably at most 18.0% by weight, preferably at most 15.0% by weight, preferably at most 12.0% by weight, preferably at most 10.0% by weight, preferably at most 9.0% by weight, preferably at most 8.0% by weight, preferably at most 7.0% by weight, preferably at most 6.0% by weight, relative to the total weight of the polymer composition.
16. Fibres according to any one of the previous statements, wherein the combined weight fraction of the first polymer and the second polymer together amounts to at least 1.0% by weight, preferably at least 2.0% by weight, preferably at least 3.0% by weight, preferably at least 4.0% by weight, preferably at least 5.0% by weight, preferably at least 6.0% by weight, preferably at least 7.0% by weight, preferably at least 8.0% by weight, preferably at least 8.5% by weight, preferably at least 9.0% by weight, relative to the total weight of the polymer composition.
17. Fibres according to any one of the previous statements, wherein the combined weight fraction of the first polymer, the second polymer and the fatty acid bisamide or the alkyl-substituted fatty acid monoamide together, amounts to at most 20.0% by weight, preferably at most 18.0% by weight, preferably at most 16.0% by weight, preferably at most 15.0% by weight, preferably at most 14.0% by weight, preferably at most 13.0% by weight, preferably at most 12.0% by weight, preferably at most 11.0% by weight, preferably at most 10.0% by weight, preferably at most 9.0% by weight, relative to the total weight of the polymer composition.
18. Fibres according to any one of the previous statements, wherein the weight fraction of the polylactide (PLA) polymer in the polymer composition is at least 75.0% by weight, preferably at least 80.0% by weight, preferably at least 85.0% by weight, preferably at least 90.0% by weight, preferably at least 91.0% by weight, relative to the total weight of the polymer composition.
19. Fibres according to any one of statements 4 to 18, wherein the ratio of the weight fraction of the second polymer over the weight fraction of the first polymer in the polymer composition is at least 1/5, preferably at least 1/4, preferably at least 1/3, preferably at least 1/2, preferably at least 2/3, preferably at least 3/4.
20. Fibres according to any one of statements 4 to 19, wherein the ratio of the weight fraction of the second polymer over the weight fraction of the first polymer in the polymer composition is at most 1/1, preferably at most 3/4, preferably at most 2/3, preferably at most 1/2, preferably at most 1/3.
21. Fibres according to any one of statements 4 to 20, wherein the ratio of the weight fraction of the second polymer over the weight fraction of the first polymer in the polymer composition is at least 1/5 to at most 1/1, preferably at least 1/4 to at most 3/4, preferably at least 1/4 to at most 2/3, preferably at least 1/4 to at most %, preferably at least 1/4 to at most 1/3.
22. Fibres according to any one of the previous statements, wherein the polymer composition comprises from at least 0.5% by weight to at most 7.0% by weight of the fatty acid bisamide or the alkyl-substituted fatty acid monoamide, relative to the total weight of the polymer composition, preferably at least 0.6% by weight to at most 5.0% by weight, preferably at least 0.7% by weight to at most 3.0% by weight, preferably at least 0.8% by weight to at most 2.0% by weight, preferably at least 0.9% by weight to at most 1.5% by weight, preferably at least 0.9% by weight to at most 1.3% by weight, preferably at least 0.9% by weight to at most 1.2% by weight of the fatty acid bisamide or the alkyl-substituted fatty acid monoamide.
23. Fibres according to any one of the previous statements, wherein the fatty acid in the fatty acid bisamide or the alkyl-substituted fatty acid monoamide is a C-12 to C-26 fatty acid, preferably a C-14 to C-24 fatty acid, preferably a C-16 to C-22 fatty acid, preferably a C-16 to C-20 fatty acid, preferably a C-16 to C-18 fatty acid.
24. Fibres according to any one of the previous statements, wherein the fatty acid in the fatty acid bisamide or the alkyl-substituted fatty acid monoamide is a saturated fatty acid.
25. Fibres according to any one of the previous statements, wherein the composition comprises fatty acid bisamide.
26. Fibres according to any one of the previous statements, wherein the fatty acid bisamide is selected from the group comprising N,N′-ethylenebis(stearamide) (also named ethylene-bisamide stearate), N,N′-methylenebis(caprylamide) (also named methylene-bisamide caprylate), N,N′-methylenebis(capramide) (also named methylene-bisamide caprate), N,N′-methylenebis(lauramide) (also named methylene-bisamide laurate), N,N′-methylenebis(myristamide) (also named methylene-bisamide myristate), N,N′-methylenebis(palmitamide) (also named methylene-bisamide palmitate), N,N′-methylenebis(stearamide) (also named methylene-bisamide stearate), N,N′-methylenebis(isostearamide) (also named methylene-bisamide isostearate), N,N′-methylenebis(behenamide) (also named methylene-bisamide behenate), N,N′-methylenebis(oleamide) (also named methylene-bisamide oleate), N,N′-methylenebis(erucamide) (also named methylene-bisamide erucinate), N,N′-ethylenebis(caprylamide) (also named ethylene-bisamide caprylate), N,N′-ethylenebis(capramide) (also named ethylene-bisamide caprate), N,N′-ethylenebis(lauramide) (also named ethylene-bisamide laurate), N,N′-ethylenebis(myristamide) (also named ethylene-bisamide myristate), N,N′-ethylenebis(palmitamide) (also named ethylene-bisamide palmitate), N,N′-ethylenebis(isostearamide) (also named ethylene-bisamide isostearate), N,N′-ethylenebis(behenamide) (also named ethylene-bisamide behenate), N,N′-ethylenebis(oleamide) (also named ethylene-bisamide oleate), N,N′-ethylenebis(erucamide) (also named ethylene-bisamide erucinate), N,N′-1,4-butanediylbis(stearamide) (also named butylene-bisamide stearate), N,N′-1,4-butanediylbis(behenamide) (also named butylene-bisamide behenate), N,N′-1,4-butanediylbis(oleamide) (also named butylene-bisamide oleate), N,N′-1,4-butanediylbis(erucamide) (also named butylene-bisamide erucinate), N,N′-(1,6-hexanediyl)bis(stearamide) (also named hexamethylene-bisamide stearate), N,N′-(1,6-hexanediyl)bis(behenamide) (also named hexamethylene-bisamide behenate), N,N′-(1,6-hexanediyl)bis(oleamide) (also named also named hexamethylene-bisamide oleate), N,N′-(1,6-hexanediyl)bis(erucamide) (also named hexamethylene-bisamide erucinate), N,N′-[1,3-phenylenebis(methylene)]bis(stearamide) (also named m-xylylene-bisamide stearate), N,N′-[1,3-phenylenebis(methylene)]bis(12-hydroxystearamide) (also named m-xylylene-bis-12-amide hydroxystearate), N,N′-[1,4-phenylenebis(methylene)]bis(stearamide) (also named p-xylylene-bisamide stearate), N,N′-[1,4-phenylene]bis(stearamide) (also named p-phenylene-bisamide stearate), N,N′-distearyl amide adipate, N,N′-distearyl amide sebacate, N,N′-dioleyl amide adipate, N,N′-dioleyl amide sebacate, N,N′-distearyl amide isophthalate, N,N′-distearyl amide terephthalate, N,N′-methylenebis(hydroxystearamide) (also named methylene-bisamide hydroxystearate), N,N′-ethylenebis(hydroxystearamide) (also named ethylene-bisamide hydroxystearate), N,N′-1,4-butanediylbis(hydroxystearamide) (also named butylene-bisamide hydroxystearate), N,N′-(1,6-hexanediyl)bis(hydroxystearamide) (also named hexamethylene-bisamide hydroxystearate), and mixtures thereof.
27. Fibres according to any one of the previous statements, wherein the alkyl-substituted fatty acid monoamide is selected from the group comprising N-lauryl amide laurate, N-palmityl amide palmitate, N-stearyl amid stearate, N-behenyl amide behenate, N-oleyl amid oleate, N-stearyl amid oleate, N-oleyl amid stearate, N-stearyl amid eruciate, N-oleyl amid palmitate, methylol amide stearate, methylol amid behenate, N-stearyl-12-hydroxy amide stearate, N-oleyl 12 hydroxy amide stearate and mixtures thereof.
28. Fibres according to any one of the previous statements, wherein the fatty acid bisamide is selected from the group comprising N,N′-ethylenebis(stearamide), N,N′-methylenebis(caprylamide), N,N′-methylenebis(capramide), N,N′-methylenebis(lauramide), N,N′-methylenebis(myristamide), N,N′-methylenebis(palmitamide), N,N′-methylenebis(stearamide), N,N′-methylenebis(isostearamide), N,N′-methylenebis(behenamide), N,N′-methylenebis(oleamide), N,N′-methylenebis(erucamide), N,N′-ethylenebis(caprylamide), N,N′-ethylenebis(capramide), N,N′-ethylenebis(lauramide), N,N′-ethylenebis(myristamide), N,N′-ethylenebis(palmitamide), N,N′-ethylenebis(isostearamide), N,N′-ethylenebis(behenamide), N,N′-ethylenebis(oleamide), N,N′-ethylenebis(erucamide), N,N′-1,4-butanediylbis(stearamide), N,N′-1,4-butanediylbis(behenamide), N,N′-1,4-butanediylbis(oleamide), N,N′-1,4-butanediylbis(erucamide), N,N′-(1,6-hexanediyl)bis(stearamide), N,N′-(1,6-hexanediyl)bis(behenamide), N,N′-(1,6-hexanediyl)bis(oleamide), N,N′-(1,6-hexanediyl)bis(erucamide), N,N′-[1,3-phenylenebis(methylene)]bis(stearamide), N,N′-[1,3-phenylenebis(methylene)]bis(12-hydroxystearamide), N,N′-[1,4-phenylenebis(methylene)]bis(stearamide), N,N′-[1,4-phenylene]bis(stearamide), N,N′-methylenebis(hydroxystearamide), N,N′-ethylenebis(hydroxystearamide), N,N′-1,4-butanediylbis(hydroxystearamide), N,N′-(1,6-hexanediyl)bis(hydroxystearamide), and mixtures thereof.
29. Fibres according to any one of the previous statements, wherein the fatty acid bisamide is selected from the group comprising N,N′-ethylenebis(stearamide), N,N′-ethylenebis(caprylamide), N,N′-ethylenebis(capramide), N,N′-ethylenebis(lauramide), N,N′-ethylenebis(myristamide), N,N′-ethylenebis(palmitamide), N,N′-ethylenebis(isostearamide), N,N′-ethylenebis(behenamide), N,N′-ethylenebis(oleamide), N,N′-ethylenebis(erucamide), and mixtures thereof.
30. Fibres according to any one of the previous statements, wherein the fatty acid of the fatty acid bisamide or the alkyl-substituted fatty acid monoamide is a stearic acid.
31. Fibres according to any one of the previous statements, wherein the fatty acid bisamide is N,N′-ethylenebis(stearamide) (EBS).
32. Fibres according to any one of the previous statements, wherein the polylactide polymer has a melt flow index of at least 5.0 g/10 min to at most 35.0 g/10 min, preferably at least 10.0 g/10 min to at most 35.0 g/10 min, preferably at least 15.0 g/10 min to at most 30.0 g/10 min, preferably at least 20.0 g/10 min to at most 28.0 g/10 min, preferably at least 22.0 g/10 min to at most 26.0 g/10 min according to ISO 1133-A, 2011 as measured at 210° C., under a load of 2.16 kg).
33. Fibres according to any one of the previous statements, wherein the polylactide polymer has a melt flow index of at least 3.0 g/10 min to at most 20.0 g/10 min, preferably at least 5.0 g/10 min to at most 20.0 g/10 min, preferably at least 6.0 g/10 min to at most 17.0 g/10 min, preferably at least 7.0 g/10 min to at most 15.0 g/10 min, preferably at least 8.0 g/10 min to at most 12.0 g/10 min according to ISO 1133-A, 2011 as measured at 190° C., under a load of 2.16 kg).
34. Fibres according to any one of the previous statements, wherein the melting temperature of the polylactide polymer is at least 110° C. to at most 240° C., preferably at least 140° C. to at most 230° C., preferably at least 155° C. to at most 200° C., preferably at least 160° C. to at most 180° C., as measured by DSC according to ISO 11357-1, 2016.
35. Fibres according to any one of the previous statements, wherein the fibre is made of at least 90% by weight of the polymer composition, preferably of at least 95% by weight of the polymer composition, preferably of at least 98% by weight of the polymer composition.
36. Fibres according to any one of the previous statements, wherein the polymer composition is a blend, preferably a mix-blend.
37. Fibres according to any one of the previous statements, wherein the fibres are as-spun fibres.
38. Fibres according to any one of the previous statements, wherein the fibres are drawn.
39. Fibres according to any one of the previous statements, wherein the fibres are crimped.
40. Fibres according to any one of the previous statements, wherein the fibres are staple fibres.
41. Fibres according to any one of the previous statements, wherein the length of the fibres is at least 3 mm to at most 60 mm, preferably at least 5 mm to at most 50 mm, preferably at least 7 mm to at most 45 mm, preferably at least 10 mm to at most 40 mm, preferably at least 15 mm to at most 38 mm.
42. Fibres according to any one of the previous statements, wherein the linear density of the fibres is at least 1.0 dtex to at most 4.0 dtex, preferably at least 1.1 dtex to at most 3.5 dtex, preferably at least 1.2 dtex to at most 3.0 dtex, preferably at least 1.3 dtex to at most 2.0 dtex, preferably at least 1.3 dtex to at most 1.5 dtex.
43. Fibres according to any one of the previous statements, wherein the length of the fibres is at least 3 mm to at most 60 mm, and the linear density of the fibres is at least 1.0 dtex to at most 4.0 dtex.
44. A non-woven, comprising the fibres according to any one of statements 1 to 43.
45. The non-woven according to statement 44, wherein the non-woven is a spunlace non-woven or a thermobonded, e.g., heat calendered, non-woven, preferably a spunlace non-woven.
46. The non-woven according to any one of statements 44 or 45, comprising at least 10% by weight to at most 100% by weight of fibres relative to the total weight of the non-woven, preferably at least 15% by weight to at most 90% by weight, preferably at least 20% by weight to at most 80% by weight, preferably at least 25% by weight to at most 70% by weight, preferably at least 30% by weight to at most 60% by weight, preferably at least 35% by weight to at most 50% by weight, preferably at least 40% by weight to at most 45% by weight, preferably 40% by weight of fibres according to any one of statements 1 to 39.
47. The non-woven according to any one of statements 44 to 46, further comprising other natural, semi-synthetic and/or synthetic fibres.
48. The non-woven according to any one of statements 44 to 47, further comprising viscose fibres.
49. Use of a blend as softening agent for polylactide (PLA) polymer fibres, wherein the blend comprises:
   a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
   a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and,
   a fatty acid bisamide or an alkyl-substituted fatty acid monoamide.
50. Use of a blend as softening agent for polylactide (PLA) polymer non-wovens, wherein the blend comprises:
   a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
   a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and,
   a fatty acid bisamide or an alkyl-substituted fatty acid monoamide.
51. Use according to any one of statements 49 or 50, wherein the blend further comprises polylactide (PLA) polymer.
52. A process for producing fibres, preferably fibres according to any one of statements 1 to 43, comprising the steps of:
   a) providing a polymer composition comprising:
      from at least 70.0% by weight to at most 97.5% by weight polylactide (PLA) polymer;
      from at least 1.0% by weight to at most 10.0% by weight of a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
      from at least 1.0% by weight to at most 10.0% by weight of a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC), wherein said first and second polymers are selected such as not to be the same; and
      from at least 0.5% by weight to at most 10.0% by weight of a fatty acid bisamide or an alkyl-substituted fatty acid monoamide;
   b) processing the polymer composition into fibres.
53. The process according to statement 52, wherein processing the polymer composition into fibres is done by extrusion, preferably through capillaries of a spinneret.
54. The process according to any one of statements 52 or 53, wherein the temperature of the spinneret is at least 200° C., preferably at least 205° C., preferably at least 210° C., preferably at least 215° C., preferably at least 220° C., preferably at least 225° C., preferably at least 230° C.
55. The process according to any one of statements 52 to 54, wherein the process comprises a step of drawing the fibres obtained in step b), preferably an off-line drawing step.
56. The process according to any one of statements 52 to 55, wherein the process comprises a step of drawing the fibres obtained in statement 54, preferably an off-line drawing step.
57. The process according to any one of statements 52 to 56, wherein the total draw ratio is at least 2.00, preferably at least 2.25, preferably at least 2.50, preferably at least 2.75, preferably at least 3.00, preferably at least 3.25.
58. The process according to any one of statements 52 to 57, wherein the polymer composition is provided by melt-mixing at least part of the PLA, the first polymer, the second polymer and the fatty acid bisamide or an alkyl-substituted fatty acid monoamide, preferably at a temperature of at least 165° C., preferably at least 170° C., preferably at least 175° C., preferably at least 180° C., preferably at least 185° C., preferably at least 190° C., preferably at least 195° C., preferably at least 200° C., preferably at least 205° C.
59. The process according to any one of statements 52 to 58, wherein the polymer composition is provided by:
   melt-mixing at least part of the PLA, the first polymer, the second polymer and the fatty acid bisamide or an alkyl-substituted fatty acid monoamide, preferably at a temperature of at least 165° C., preferably at least 170° C., preferably at least 175° C., preferably at least 180° C., preferably at least 185° C., preferably at least 190° C., preferably at least 195° C., preferably at least 200° C., preferably at least 205° C., obtaining a master mix; and,
   dry-blending the remaining PLA with the master mix.
60. A process for producing non-wovens comprising the steps of:
   arranging fibres obtained in any one of statements 1 to 43 in a web or in two or more cross-lapped webs; and,
   consolidating the web(s).
61. The process according to statement 60, wherein the arranging of the fibres comprises the step of carding the fibres.
62. The process according to any one of statements 60 or 61, wherein the consolidating of the web(s) is accomplished by thermobonding, heat calendaring, hydroentanglement, needle punching, or chemical bonding, preferably by hydroentanglement, thermobonding or heat calendaring, preferably by hydroentanglement.
63. An article comprising a non-woven according to any one of statements 44 to 48 or produced by a method according to any one of statements 60 to 62, preferably wherein the article is a garment, a mask, a wipe or a hygiene product.
64. The article according to statement 63, wherein the article is a hygiene product, such as a diaper or a sanitary pad.
65. Use of a non-woven according to any one of statements 44 to 48 or produced by a method according to any one of statements 60 to 62, as a contact layer, dispersion layer or an absorbing layer in an article, preferably a hygiene product.

The present invention is based on the surprising finding that when a combination of a first polymer, a second polymer and a fatty acid bisamide or an alkyl-substituted fatty acid monoamide as defined herein is added to PLA, fibres made from such a PLA composition are softer than neat PLA, but the tenacity of the fibres does not decrease compared to neat PLA. Hence, the mechanical strength of the fibres of the invention is at least comparable with fibres made from neat PLA, even though the fibres of the invention are softer. It has further been observed that the crimp elasticity of the fibres of the invention increased compared to neat PLA. Fibres of the invention have a high ability to recover from deformation. The fibres of the invention therefore feel bulky. Also, non-wovens of the invention, i.e., nonwovens comprising fibres of the invention, are softer to touch compared to non-wovens comprising fibres made from neat PLA. The non-wovens of the invention appear to be mechanically stronger, thicker, even under pressure and display a higher compression.

As used herein the term “fibre” refers to a single strand of elongated material, preferably untwisted elongated material. Fibres may be crimped or uncrimped. Fibres may be drawn or undrawn. The term “fibre” may include staple fibres and. “Staple fibres” are fibres of limited length, e.g., 20 to 300 mm or 20 to 120 mm.

The invention provides fibres, comprising a polymer composition. The polymer composition comprises (% by weight relative to the total weight of the composition):
from at least 70.0% by weight to at most 97.5% by weight polylactide (PLA) polymer;
from at least 1.0% by weight to at most 10.0% by weight of a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
from at least 1.0% by weight to at most 10.0% by weight of a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and
from at least 0.5% by weight to at most 10.0% by weight of a fatty acid bisamide or an alkyl-substituted fatty acid monoamide.

The terms “PLA”, “polylactide polymer”, and “polylactic acid” are used herein as synonyms.

A “PLA polymer” as used herein refers to a polymer of lactide (monomers). Lactide can exist in three different geometric structures, which have a diastereomeric relationship. The term “lactide” (or “lactide monomer”) as used herein may therefore be L-lactide (derived from two L-lactic acid molecules), D-lactide (derived from two D-lactic acid molecules), meso-lactide (derived from a L-lactic acid molecule and a D-lactic acid molecule), or a mixture of two or more of the above. A 50/50 mixture of L-lactide and D-lactide with a melting point of about 126° C. is often referred to in the literature as D,L-lactide or racemic lactide (and is also denoted as “rac-Lactide” or “racemic lactide” or “rac-lactide” herein). A PLA polymer as defined herein may thus be a polymer of lactide (monomer) selected from the group comprising L-lactide, D-lactide, meso-lactide, racemic lactide and any mixture of two or more thereof.

In certain embodiments, a PLA polymer as defined herein is a polymer of lactide (monomer) as defined herein only, i.e., such polymer does not comprise any other monomer which is not a lactide. In certain embodiments, a PLA polymer which does not comprise any monomer which is not a lactide, is also denoted herein as a “PLA homopolymer”. Such PLA homopolymer may thus consist of lactide, e.g., lactide which is selected from the group comprising L-lactide, D-lactide, meso-lactide, racemic lactide and any mixture of two or more thereof.

In certain embodiments, the PLA polymer is selected from the group comprising, and preferably consisting of, poly(L-lactic acid) (PLLA), poly(D-lactic acid) (PDLA), and poly(L-, D-lactic acid) (PLDLA), and any mixture thereof. Stereocomplexes of PLLA and PDLA, as described for example in WO 2010/097463, can also be used as PLA polymer.

The process for preparing PLA is well-known by the person skilled in the art.

In certain embodiments, the PLA polymer may comprise limited amounts of a comonomer which is not a lactide as defined herein. More in particular, the PLA polymer may include a PLA copolymer, i.e., a copolymer of a lactide and a non-lactide comonomer. The term “PLA copolymer” as used herein intends to refer to a polymer of lactide (monomer) (as defined herein) and a comonomer which is not lactide (i.e., a non-lactide comonomer).

In a certain embodiment, a non-lactide comonomer is selected from the group comprising urethanes, carbonates, lactones. For instance, copolymers of lactide and trimethylene carbonate may be used. For instance, copolymers of lactide and urethanes may be used. For instance, copolymers of lactide and lactones may be used. In a preferred embodiment, said comonomer is a lactone. Preferably said lactone is selected from the group comprising caprolactone, valerolactone, and butyrolactone. For instance, copolymers of lactide and caprolactone may be used in the polymer composition.

In some embodiments, the introduction of comonomers to PLA can increase the ductility (i.e., decreases the brittleness) of the PLA. Additionally, it is appreciated that if polymer composition comprises a PLA copolymer, as defined herein such PLA copolymer comprises a non-lactide comonomer content in a very specific range. Preferably, the amount of a non-lactide comonomer in a PLA copolymer, for use in the present invention, is at most 30% by weight, based on the total weight of the PLA copolymer, and preferably comprised between 1 and 20% by weight or between 1 and 10% by weight, or between 2 and 7% by weight, or between 2 and 5% by weight, based on the total weight of the PLA copolymer. A PLA copolymer as applied herein can be understood to mean any type of copolymer, including but not limited to a random copolymer, a block copolymer, a gradient copolymer, and a statistical copolymer.

Polybutylene succinate (PBS), as defined herein, refers to a polymer that may be classified as a polyester, more preferably an aliphatic polyester, and most preferably a biodegradable aliphatic polyester. Polybutylene succinate comprises of repeating units of butylene succinate and can be represented by structure (II):

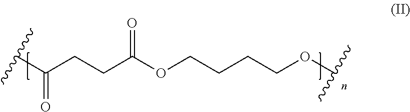

In the art, various ways of producing polybutylene succinate are known. In some embodiments, the process for producing PBS involves the esterification of succinic acid with 1,4-butanediol with the elimination of water, to form oligomers, which is followed by a trans-esterification under vacuum in the presence of a catalyst such as titanium, zirconium, tin or germanium derivatives, to provide high molecular mass polymer. A skilled person will know Mutatis mutandis how to prepare PES, PPS, PBA, and PBSA.

Polybutylene succinate terephthalate (PBST), also known as poly(butylene succinate-co-butylene terephthalate), as defined herein, refers to a polyester comprising butylene succinate units and butylene terephthalate units.

Polybutylene adipate terephthalate (PBAT), as defined herein, refers to a biodegradable random copolymer, specifically a co-polyester of adipic acid, 1,4-butanediol and dimethyl terephthalate as represented in structure (III).

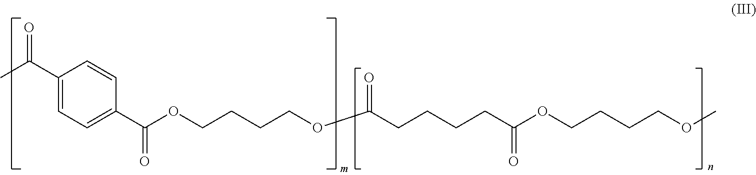

Polycaprolactone (PCL), as defined herein, refers to a polymer that can be obtained by polymerization of caprolactone, more preferably ε-caprolactone. Preferably, the polymerization can be carried out via ring opening polymerization, more preferably anionic ring opening polymerization. The polymerization may be carried out in the presence of an initiator and/or a catalyst. Both suitable initiators and catalyst are known in the art. Examples of suitable initiators are nucleophilic reagents, such as metal amides, alkoxides, phosphines, amines, alcohols, water or organometals, e.g., alkyl lithium, alkyl magnesium bromide, alkyl aluminium, etc. Examples of suitable catalysts are stannous (II) 2-ethylhexanoate a.k.a. stannous octoate or [Sn(Oct)₂], aluminium tri-isopropoxide, lanthanide isopropoxide.

Polycaprolactone can comprise structure (IV) as repeating motif, with the end groups depending on the used initiator and/or catalyst.

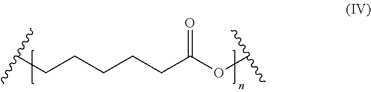

Polyhydroxyalkanoate (PHA), as defined herein, refers to a polymer that may be classified as a polyester, preferably a linear polyester. Polyhydroxyalkanoate may be produced by bacterial fermentation of lipids and sugar, such as glucose. In some embodiments, the polyhydroxyalkanoate may be produced biosynthetically. In some embodiments, the polyhydroxyalkanoate is biodegradable.

Polypropylene carbonate (PPC), as defined herein, refers to a copolymer of carbon dioxide and propylene oxide. The polymer is thermoplastic and is typically formed by using zinc glutarate as catalyst during polymerization. The repeating motif of PPC may be represented by structure (V):

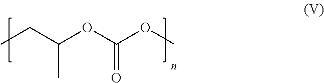

In certain embodiments, the weight fraction of the first polymer and the second polymer together amounts to at most 20.0% by weight, preferably at most 18.0% by weight, preferably at most 15.0% by weight, preferably at most 12.0% by weight, preferably at most 10.0% by weight, preferably at most 9.0% by weight, preferably at most 8.0% by weight, preferably at most 7.0% by weight, preferably at most 6.0% by weight, compared to the total weight of the polymer composition. Such amounts of first and second polymer in the polymer composition still allows for the fibres to be formed by extrusion trough a spinneret.

In a certain embodiment, the fibres comprise a polymer composition, wherein said polymer composition comprises, relative to the total weight of the polymer composition:
from at least 87.5% by weight to at most 95.5% by weight of polylactide (PLA) polymer, preferably at least 89.3% by weight to at most 93.8% by weight of polylactide (PLA) polymer;
from at least 3.0% by weight to at most 8.0% by weight of the first polymer, preferably at least 4.0% by weight to at most 7.0% by weight, wherein the first polymer is selected from the group comprising polybutylene succinate (PBS), poly(ethylene succinate) (PES), poly(propylene succinate) (PPS), polybutylene adipate (PBA), polybutylene succinate adipate (PBSA), and polybutylene succinate terephthalate (PBST); preferably the first polymer is PBS;
from at least 1.0% by weight to at most 2.5% by weight of the second polymer, preferably at least 1.5% by weight to at most 2.2% by weight, wherein the second polymer is selected from the group comprising polybutylene adipate terephthalate (PBAT), polycaprolactone (PCL), polyhydroxyalkanoates (PHA), and polypropylene carbonate (PPC); preferably the second polymer is PBAT; and,
from at least 0.5% by weight to at most 2.0% by weight of a fatty acid bisamide or an alkyl-substituted fatty acid monoamide, preferably at least 0.7% by weight to at most 1.5% by weight of a fatty acid bisamide or an alkyl-substituted fatty acid monoamide.

The term “fatty acid bisamide” as used herein refers to a fatty acid amid having two amid bonds in a single molecular and, for example, N,N′-ethylenebis(stearamide) (also named ethylene-bisamide stearate), N,N′-methylenebis(caprylamide) (also named methylene-bisamide caprylate), N,N′-methylenebis(capramide) (also named methylene-bisamide caprate), N,N′-methylenebis(lauramide) (also named methylene-bisamide laurate), N,N′-methylenebis(myristamide) (also named methylene-bisamide myristate), N,N′-methylenebis(palmitamide) (also named methylene-bisamide palmitate), N,N′-methylenebis(stearamide) (also named methylene-bisamide stearate), N,N′-methylenebis(isostearamide) (also named methylene-bisamide isostearate), N,N′-methylenebis(behenamide) (also named methylene-bisamide behenate), N,N′-methylenebis(oleamide) (also named methylene-bisamide oleate), N,N′-methylenebis(erucamide) (also named methylene-bisamide erucinate), N,N′-ethylenebis(caprylamide) (also named ethylene-bisamide caprylate), N,N′-ethylenebis(capramide) (also named ethylene-bisamide caprate), N,N′-ethylenebis(lauramide) (also named ethylene-bisamide laurate), N,N′-ethylenebis(myristamide) (also named ethylene-bisamide myristate), N,N′-ethylenebis(palmitamide) (also named ethylene-bisamide palmitate), N,N′-ethylenebis(isostearamide) (also named ethylene-bisamide isostearate), N,N′-ethylenebis(behenamide) (also named ethylene-bisamide behenate), N,N′-ethylenebis(oleamide) (also named ethylene-bisamide oleate), N,N′-ethylenebis(erucamide) (also named ethylene-bisamide erucinate), N,N′-1,4-butanediylbis(stearamide) (also named butylene-bisamide stearate), N,N′-1,4-butanediylbis(behenamide) (also named butylene-bisamide behenate), N,N′-1,4-butanediylbis(oleamide) (also named butylene-bisamide oleate), N,N′-1,4-butanediylbis(erucamide) (also named butylene-bisamide erucinate), N,N′-(1,6-hexanediyl)bis(stearamide) (also named hexamethylene-bisamide stearate), N,N′-(1,6-hexanediyl)bis(behenamide) (also named hexamethylene-bisamide behenate), N,N′-(1,6-hexanediyl)bis(oleamide) (also named also named hexamethylene-bisamide oleate), N,N′-(1,6-hexanediyl)bis(erucamide) (also named hexamethylene-bisamide erucinate), N,N′-[1,3-phenylenebis(methylene)]bis(stearamide) (also named m-xylylene-bisamide stearate), N,N′-[1,3-phenylenebis(methylene)]bis(12-hydroxystearamide) (also named m-xylylene-bis-12-amide hydroxystearate), N,N′-[1,4-phenylenebis(methylene)]bis(stearamide) (also named p-xylylene-bisamide stearate), N,N′-[1,4-phenylene]bis(stearamide) (also named p-phenylene-bisamide stearate), N,N′-distearyl amide adipate, N,N′-distearyl amide sebacate, N,N′-dioleyl amide adipate, N,N′-dioleyl amide sebacate, N,N′-distearyl amide isophthalate, N,N′-distearyl amide terephthalate, N,N′-methylenebis(hydroxystearamide) (also named methylene-bisamide hydroxystearate), N,N′-ethylenebis(hydroxystearamide) (also named ethylene-bisamide hydroxystearate), N,N′-1,4-butanediylbis(hydroxystearamide) (also named butylene-bisamide hydroxystearate), N,N′-(1,6-hexanediyl)bis(hydroxystearamide) (also named hexamethylene-bisamide hydroxystearate), and so on may be cited.

The term “alkyl-substituted fatty acid monoamide” refers to compounds where amide hydrogen of fatty acid monoamide is substituted with an alkyl group and, for example, N-lauryl amide laurate, N-palmityl amide palmitate, N-stearyl amid stearate, N-behenyl amide behenate, N-oleyl amid oleate, N-stearyl amid oleate, N-oleyl amid stearate, N-stearyl amid eruciate, N-oleyl amid palmitate, and so on can be cited. The alkyl group may have a substituent such as hydroxyl group introduced in its structure and, for example, methylol amide stearate, methylol amid behenate, N-stearyl-12-hydroxy amide stearate, N-oleyl 12 hydroxy amide stearate, and so on are also included in the alkyl-substituted fatty acid monoamide.

The fibres of the invention may be produced by methods well known to the skilled person. The polymer composition may be melted in an extruder, in general passed through a melt pump to ensure a constant feeding rate and then extruded through a number of fine capillaries of a spinneret. The still molten fibres may simultaneously be cooled by air, drawn to a final diameter and collected. Optionally, the so-obtained fibres may be subjected to a further drawing step. The fibres are for example collected on a winder or other suitable collecting means.

The nonwovens of the invention may be produced by any suitable processes, such as spunbonding process and the melt blown process. Alternatively, the fibres of the invention may be collected and arranged in a web, optionally such webs being cross lapped, followed by a consolidating step, such as thermobonding, heat calendaring, hydroentanglement, needle punching, or chemical bonding. In preferred embodiments, the consolidating step involves heat calendaring or hydroentanglement When arranging the fibres of the invention into a web, the fibres of the invention may be mixed with other fibres, such as viscose fibres.

In the spunbonding process the polymer composition may be melted in an extruder, in general first passed through a melt pump to ensure a constant feeding rate and then extruded from a number of fine, usually circular, capillaries of a spinneret, thus obtaining filaments. The filament formation can either be done by using one single spinneret with a large number of holes, generally several thousand, or by using several smaller spinnerets with a correspondingly lower number of holes per spinneret. After exiting from the spinneret, the still molten filaments are quenched by a current of air. The diameter of the filaments is then quickly reduced by a flow of high-velocity air. Air velocities in this drawdown step can range up to several thousands of meters per minute. After drawdown the filaments are collected on a support, for example a forming wire or a porous forming belt, thus first forming an unbonded web, which is then passed through compaction rolls and finally through a consolidating step. Consolidating of the fabric may be accomplished as described herein.

In the melt blown process the polymer composition can be melted in an extruder, in general first passed through a melt pump to ensure a constant feeding rate and then through the capillaries of a special melt blowing die. Usually melt blowing dies have a single line of usually circular capillaries through which the molten polymer passes. After exiting from the die, the still molten filaments are contacted with hot air at high speed, which rapidly draws the fibres and, in combination with cool air, solidifies the filaments. In the following, the nonwoven is formed by depositing the filaments directly onto a forming wire or a porous forming belt.

In some embodiments, the normalised softness of heat calendered non-wovens of the invention, in the machine direction (MD), is at most 9.50 mN/gsm, preferably at most 9.40 mN/gsm, preferably at most 9.20 mN/gsm, preferably at most 9.00 mN/gsm, preferably at most 8.80 mN/gsm, preferably at most 8.70 mN/gsm n the machine direction (MD).

In some embodiments, the normalised softness of heat calendered non-wovens of the invention, in the transverse direction (TD), is at most 3.10 mN/gsm, preferably at most 3.00 mN/gsm, preferably at most 2.80 mN/gsm, preferably at most 2.60 mN/gsm, preferably at most 2.50 mN/gsm, preferably at most 2.40 mN/gsm, in the transverse direction (TD).

In some embodiments, the normalised softness of spunlace non-wovens of the invention, in the machine direction (MD), is at most 0.750 mN/gsm, preferably at most 0.740 mN/gsm, preferably at most 0.730 mN/gsm, preferably at most 0.720 mN/gsm, preferably at most 0.710 mN/gsm, preferably at most 0.705 mN/gsm.

In some embodiments, the normalised softness of spunlace non-wovens of the invention, in the transverse direction (TD), is at most 0.0320 mN/gsm, preferably at most 0.0310 mN/gsm, preferably at most 0.0300 mN/gsm, preferably at most 0.0290 mN/gsm, preferably at most 0.0280 mN/gsm, in the transverse direction (TD).

The invention further provides the use of a blend as softening agent for polylactide (PLA) polymer fibres and/or for polylactide (PLA) polymer non-wovens, wherein the blend comprises:
a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and
a fatty acid bisamide or an alkyl-substituted fatty acid monoamide; and,
optionally polylactide (PLA) polymer.

It should be understood that certain embodiments of the polymer composition are also embodiments of the blend. The blend may be intended to be mixed, preferably mix-melted, with the polylactide (PLA) polymer which is intended to be used to fabricated in fibres or non-wovens. In the embodiments wherein the blend comprises PLA, the blend may be used to be dry-mixed with the polylactide (PLA) polymer which is intended to be used to fabricated in fibres or non-wovens. The blend may be used as master mix, to be further mixed with polylactide (PLA) polymer.

### EXAMPLES

### Materials:

The following polymer and other materials were used in the examples.

Polymer “PLA-1” is a polylactide polymer commercially available as Luminy® LX530 by Total Corbion PLA BV. PLA-1 has a melt flow index of 23 g/10 min, as measured according to ISO 1133-A, 2011 at 210° C. under a load of 2.16 kg, Melt flow index of 10 g/10 min, as measured according to ISO 1133-A, 2011 at 190° C. under a load of 2.16 kg, and a meting temperature of 165° C. as measured by DSC.

Polymer “PBS-1” is a polybutylene succinate commercially available as TH803S from Lanshan Tunhe, it has a reported melt flow index (MFI) of 25-30 g/10 min, according to ISO 1133-A, 2011 (2.16 kg @190° C.), a melting temperature of 110-116° C. according to ISO 11357-1, 2016 and a density of 1.25 g/cm³ according to ISO 1183-1, 2019.

Polymer “PBAT-1” is a poly(butylene adipate-co-terephthalate commercially available as TH801T from Lanshan Tunhe, it has a reported melt flow index (MFI) of 2.5-4.5 g/10 min, according to ISO 1133-A, 2011 (2.16 kg @190° C.)

FAB-1” is a fatty acid bisamide commercially available as KAO WAX EB-FF from KAO Oleochemical. The product is N,N′-ethylenebis(stearamide) (EBS) (CAS number 110-30-5).

“FAB-2” is a fatty acid bisamide commercially available as Stantex K1973C from Pulcra Chemicals. The product is a mixture of ethylene bis-amide of C16 and C18 fatty acids.

Commercial modifier “CM-1” is an impact modifier masterbatch for PLA commercially available as Sukano® PLA im S633 from Sukano. The product comprises PLA and a polyolefin.

Commercial modifier “CM-2” is a slip agent commercially available as Sukano® PLA pz S713 from Sukano. It is a masterbatch comprising PLA and ethylene-acrylate copolymer.

Erucamide refers to cis-13-Docosenoamide (CAS Number: 112-84-5) and was purchased form Fine Organics India.

Viscose fibres (1.2 D, 38 mm) were purchased from Yibing Grace Group.

### Testing Methods

Fibre Mechanical strength were tested according to standard GB/T 14337-2008: Testing method for tensile properties of man-made staple fibres.

Fibre crimp properties were tested according to standard GB/T 14338-2008: Testing method for crimping performance of man-made staple fibres.

Staple fibre softness evaluation:
For staple fibres, the softness was evaluated by hand feelings—pinching/touching a bundle of staple fibres.
A rating (1 to 5, 5 being the highest) were given by the experienced process engineer and product engineer.
Softness i.e., easy to deform, smoothness and bulkiness are the key characteristics.

Nonwoven Softness: measured by “Handle-o-meter” DH090 type from Ningbo Dahe Instrument Co., Ltd., followed by measures according to standard GB/T 8942-2016. This Standard specifies the method of using the hand-feeling softness tester to determine the softness of nonwoven.

Normalised softness of non-woven is the softness of the non-woven divided by the basis weight.

Nonwoven compression ratio under load was using according to standard GB/T 24442.1-2009: Textiles-Determination of compression property—Part 1: Constant Method.

### Preparation of Staple Fibres

### Comparative Example 1 (CE-1)

Neat PLA-1 was pre-dried using a vacuum drum dryer at 90° C. for 6 hrs. The dried pellets were fed into the spinning line equipped with a single screw extruder, a melt metering pump and a spinneret (1200 holes of diameter=0.25 mm, L/D=3). The extruder and spinning pack temperature were both set at about 230° C., and the as-spun yarns were picked up by godet rollers at a spinning speed of 800 m/min.

The as-spun yarns were collected, and were then subjected to off-line drawing, wherein:
in the first drawing stage, the yarns were heated in the hot water channel set at 75° C., and drawn by two groups of rollers set at different rotating speed, i.e., Group 1 rollers: 14.35 m/min; Group 2 rollers: 35.12 m/min;
subsequently, the yarns were continuously carried through the 1^{st} heating plate set at 100° C., and further drawn by the third group of rollers rotating at higher speed, i.e., Group 3 rollers: 42.9 m/min;
followed by the yarns were carried through the 2^{nd} heating plate set at 75° C., with a little drawing just to retain the tension on the yarns, and the total draw ratio was 2.99 times.

The obtained drawn yarns were crimped at the crimping station and were then conveyed through a long heating tunnel set at 100° C. for heat setting. Finally, the crimped yarns were collected and cut into staple fibres with length of 38 mm.

### Comparative Example 2 (CE-2)

Firstly, a masterbatch was prepared by melt mixing 20.0% by weight of FAB-2 and 80.0% by weight of PLA-1 using a twin-screw extruder (diameter=35 mm, L/D=44) at a temperature of 200° C. Subsequently, 15.0% by weight of the prepared masterbatch and 85.0% by weight of PLA-1 were dry blended, pre-dried using a vacuum drum dryer at 80° C. for 6 hrs. The dried pellets were then fed into the same spinning line as CE-1 and spun with the extruder temperature and spinning pack temperature both set at about 220° C., and the spinning speed at 800 m/min.

The as-spun yarns were collected, and then subjected to off-line drawing with the same procedure as CE-1, except that the temperature of the hot water channel, the 1^{st} heating plate, the 2^{nd} heating plate set at 65° C., 100° C., and 70° C., respectively and the total draw ratio was 3.52 times.

Subsequently, the drawn yarns were crimped at the crimping station, and conveyed through a long heating tunnel set at 85° C. for heat setting. Finally, the crimped yarns were collected then cut into staple fibres with length of 38 mm. The staple fibres comprised 3.0% by weight of FAB-2.

### Comparative Example 3 (CE-3)

Firstly, a blend containing 90.0% by weight of PLA-1, 10.0% by weight of PBS-1, and 0.2% by weight of erucamide was melt-mixed using a twin-screw extruder (diameter=35 mm, L/D=44) at 190° C. The resulting compounded pellets were then pre-dried by a vacuum drum dryer for more than 6 hrs at 90° C. The dried pellets were then fed into the same spinning line as CE-1 and spun with the extruder temperature and spinning pack temperature both set at about 215° C., and the spinning speed at 800 m/min.

The as-spun yarns were collected, and then subjected to off-line drawing with the same procedure as CE-1, except that the temperature of the hot water channel, the 1^{st} heating plate, the 2^{nd} heating plate was set at 70° C., 100° C., and 70° C., respectively, and the total draw ratio was 2.3 times.

Subsequently, the drawn yarns were crimped at the crimping station, and were then conveyed through a long heating tunnel set at 100° C. for heat setting. Finally, the crimped yarns were collected then cut into staple fibres with length of 38 mm. The staple fibres comprised 10.0% by weight of PBS-1.

### Comparative Example 4 (CE-4)

3.0% by weight of CM-1 and 97.0% by weight of PLA-1 were dry blended, and pre-dried by a vacuum drum dryer for more than 6 hrs at 90° C. Subsequently, the dried pellets were used to spin fibres using the same spinning line as CE-1, except that the spinning temperature was set at 225° C.

The as-spun yarns were collected, and then subjected to off-line drawing with the same procedure as CE-1, except that the temperature of the hot water channel, the 1^{st} heating plate, the 2^{nd} heating plate set at 70° C., 100° C., and 70° C., respectively, and the total draw ratio was 3.12 times.

The drawn yarns were crimped at the crimping station and were then conveyed through a long heating tunnel set at 100° C. for heat setting. Finally, the crimped yarns were collected and then also cut into staple fibres with length of 38 mm. The staple fibres comprise 3.0% by weight of CM-1.

### Comparative Example 5 (CE-5)

7.0% by weight of CM-2 and 93.0% by weight of PLA-1 were dry blended and pre-dried by a vacuum drum dryer for more than 6 hrs at 90° C. Subsequently, the dried pellets were used to spin fibres using the same spinning line and at the same conditions as CE-4, except that the spinning temperature was set at 230° C.

The as-spun yarns were also off-line drawn and heat set with the same procedure as CE-4, but the total draw ratio was 3.4 times. Finally, the crimped yarns were collected and then cut into staple fibres with length of 38 mm. The staple fibres comprised 7.0% by weight of CM-2.

### Comparative Example 6 (CE-6)

5.0% by weight of PBAT-1 and 95.0% by weight of PLA-1 was dry blended, and pre-dried by a vacuum drum dryer for more than 6 hrs at 90° C. Subsequently the dried pellets were used to spin fibres using the same spinning line and at the same conditions as CE-1, except that the temperature of the hot water channel, the 1^{st} heating plate, the 2^{nd} heating plate set at 70° C., 100° C., and 70° C., respectively, and the total draw ratio was 3.34 times.

The drawn yarns were crimped at the crimping station and were then conveyed through a long heating tunnel set at 100° C. for heat setting. Finally, the crimped yarns were collected and then cut into staple fibres with length of 38 mm. The staple fibres comprised 5.0% by weight of PBAT-1.

### Comparative Example 7 (CE-7)

Firstly, a masterbatch was prepared by melt mixing 10.0% by weight of FAB-1 and 90.0% by weight of PLA-1 using a twin-screw extruder at the temperature of 200° C. Subsequently 20.0% by weight of the prepared masterbatch and 80.0% by weight of PLA-1 were dry blended, and pre-dried by a vacuum drum dryer for more than 6 hrs at 90° C. The dried pellets were used to spin fibres using the same spinning line and at the same conditions as CE-1, except that the spinning temperature was set at 238° C.

The as-spun yarns were also off-line drawn with the same procedure as CE-1 and the final total draw ratio was 2.97 times. The drawn yarns were crimped at the crimping station and were then conveyed through a long heating tunnel set at 95° C. for heat setting. Finally, the crimped yarns were cut into staple fibres with length of 38 mm. The staple fibres comprised 2.0% by weight of FAB-1.

### Comparative Example 8 (CE-8)

Firstly, a masterbatch was prepared by melt mixing 20.0% by weight of FAB-2 and 80.0% by weight of PLA-1 using a twin-screw extruder (diameter=35 mm, L/D=44) at the temperature of 200° C.

Subsequently 10.0% by weight of the prepared masterbatch, 8.0% by weight of PBS-1 and 82.0% by weight of PLA-1 were dry blended, and pre-dried by a vacuum drum dryer for more than 6 hrs at 90° C. The dried pellets were used to spin fibres using the same spinning line and at the same conditions as CE-1, except that the spinning temperature was set at 230° C.

The as-spun yarns were also off-line drawn and heat set with the same procedure as CE-1, and the temperature of the hot water channel, the 1st and 2nd heating plates were set at 75, 100, and 75° C. respectively. The heat setting tunnel was set at 95° C., and the final total draw ratio was 3.34 times. Finally, the crimped yarns were cut into staple fibres with length of 38 mm. The staple fibres comprised 2.0% by weight of FAB-2 and 8.0% by weight of PBS-1.

### Comparative Example 9 (CE-9)

Firstly, a masterbatch was prepared by melt mixing 2.0% by weight of FAB-1, 12.0% by weight of PBAT-1 and 86.0% by weight of PLA-1 using a twin-screw extruder (diameter=35 mm, L/D=44) at the temperature of 200° C.

Subsequently 50.0% by weight of the prepared masterbatch and 50.0% by weight of PLA-1 were dry blended, and pre-dried by a vacuum drum dryer for more than 6 hrs at 90° C. The dried pellets were used to spin fibres using the same spinning line and at the same conditions as CE-1, except that the spinning temperature was set at 240° C.

The as-spun yarns were also off-line drawn and heat set with the same procedure as CE-1, but the hot water channel, the 1st and 2nd heating plates were set at 75, 100, and 75° C. respectively, and the heat setting tunnel was set at 95° C., and the final total draw ratio was 3.1 times. Finally, the crimped yarns were cut into staple fibres with length of 38 mm. The staple fibres comprise 1.0% by weight of FAB-1 and 6.0% by weight of PBAT-1.

### Comparative Example 10 (CE-10)

Firstly, a masterbatch was prepared by melt mixing 2.0% by weight of FAB-1, 16.0% by weight of PBS-1 and 82.0% by weight of PLA-1 using a twin-screw extruder (diameter=35 mm, L/D=44) at the temperature of 200° C.

Subsequently, 50.0% by weight of the prepared masterbatch and 50.0% by weight of PLA-1 were dry blended, and pre-dried by a vacuum drum dryer for more than 6 hrs at 90° C. The dried pellets were used to spin fibres using the same spinning line and at the same conditions as CE-1, except that the spinning temperature was set at 238° C.

The as-spun yarns were also off-line drawn and heat set with the same procedure as CE-1, but the hot water channel, the 1st and 2nd heating plates were set at 75, 100, and 75° C. respectively, and the heat setting tunnel was set at 95° C., and the final total draw ratio was 2.85 times. Finally, the crimped yarns were cut into staple fibres with length of 38 mm. The staple fibres comprise 1.0% by weight of FAB-1 and 8.0% by weight of PBS-1.

### Working Example 1 (E-1)

First, a masterbatch was prepared by melt mixing 2.0% by weight of FAB-1, 12.0% by weight of PBS-1, 4.0% by weight of PBAT-1 and 82.0% by weight of PLA-1 using a twin-screw extruder (diameter=35 mm, L/D=44) at the temperature of 200° C.

Subsequently 50.0% by weight of the prepared masterbatch and 50.0% by weight of PLA-1 were dry blended, and pre-dried by a vacuum drum dryer for more than 6 hrs at 90° C. The dried pellets were used to spin fibres using the same spinning line and at the same conditions as CE-1, except that the spinning temperature was set at 240° C.

The as-spun yarns were also off-line drawn and heat set with the same procedure as CE-1, but the hot water channel, the 1st and 2nd heating plates were set at 75, 100, and 75° C. respectively, and the heat setting tunnel was set at 95° C., and the final total draw ratio was 3.4 times. Finally, the crimped yarns were cut into staple fibres with length of 38 mm. The staple fibres comprise 1.0% by weight of FAB-1, 6.0% by weight of PBS-1 and 2.0% by weight of PBAT-1.

### Summary Processing Conditions

Table 1 shows the processing conditions for the staple fibres.

TABLE 1

| | | | Off line drawing step | | | | |
|---|---|---|---|---|---|---|---|
| | | | | 1^{st} | 2^{nd} | heat | |
| | Spinning step | | Water | heating | heating | setting | |
| # | Spinning | Spinning | channel | tunnel | tunnel | oven | Total |
| Sample | temperature | speed | temperature | temperature | temperature | temperature | Draw |
| code | (° C.) | (m/min) | (° C.) | (° C.) | (° C.) | (° C.) | Ratio |
| CE-1 | 230 | 800 | 75 | 100 | 75 | 100 | 2.99 |
| CE-2 | 220 | 800 | 65 | 100 | 70 | 85 | 3.52 |
| CE-3 | 215 | 800 | 70 | 100 | 70 | 100 | 2.30 |
| CE-4 | 225 | 800 | 70 | 100 | 70 | 100 | 3.12 |
| CE-5 | 230 | 800 | 70 | 100 | 70 | 100 | 3.40 |
| CE-6 | 242 | 800 | 70 | 100 | 70 | 100 | 3.34 |
| CE-7 | 238 | 800 | 75 | 100 | 75 | 95 | 2.97 |
| CE-8 | 230 | 800 | 75 | 100 | 75 | 95 | 3.34 |

| | | |
|---|---|---|
| # | Spinning step | Off line drawing step |

| | | | | | | | |
|---|---|---|---|---|---|---|---|
| CE-9 | 240 | 800 | 75 | 100 | 75 | 95 | 3.10 |
| CE-10 | 238 | 800 | 75 | 100 | 75 | 95 | 2.85 |
| E-1 | 240 | 800 | 75 | 100 | 75 | 95 | 3.40 |

### Properties

Table 2 shows the properties of the staple fibres.

TABLE 2

| | | Mechanical Properties | | | | | Crimp properties | | | |
|---|---|---|---|---|---|---|---|---|---|---|
| # | Additives | | Linear | | | initial | | Crimp | Crimp | Crimp |
| Sample | (% by | Draw | density | Tenacity | Elongation | modulus | Crimp | elasticity | ratio | recovery |
| code | weight) | ratio | dtex | cn/dtex | % | cN/dtex | number | % | % | % |
| CE-1 | NA | 2.99 | 2.01 | 3.51 | 45.86 | 21.12 | 13 | 73.8 | 4.39 | 3.24 |
| CE-2 | 3.0% FAB-2 | 3.52 | 2.5 | 2.01 | 47.08 | 12.47 | 20 | 71.93 | 9.36 | 6.65 |
| CE-3 | 10.0% PBS-1 | 2.30 | 2.76 | 2.87 | 55.01 | 32.88 | 17 | 84.07 | 12.18 | 10.24 |
| | 0.2% Erucamide | | | | | | | | | |
| CE-4 | 3.0% CM-1 | 3.12 | 2.5 | 2.21 | 41.56 | 30.15 | 15 | 73.36 | 9.61 | 7.05 |
| CE-5 | 7.0% CM-2 | 3.40 | 2.4 | 2.13 | 41.45 | 24.87 | 14 | 74.74 | 11.68 | 8.73 |
| CE-6 | 5.0% PBAT-1 | 3.34 | 2.43 | 3.51 | 45.65 | 38.75 | 12 | 71.5 | 15.83 | 11.32 |
| CE-7 | 2.0% FAB-1 | 2.97 | 2.08 | 1.57 | 82.26 | NA | 10 | 65.9 | 3.55 | 2.34 |
| CE-8 | 8.0% PBS-1 | 3.34 | 2.4 | 3.7 | 44.91 | 40.47 | 14 | 95.71 | 6.3 | 6.03 |
| | 2.0% FAB-2 | | | | | | | | | |
| CE-9 | 1.0% FAB-1 | 3.10 | 1.81 | 3.13 | 46.25 | ND | 18 | 72.14 | 10.37 | 8.17 |
| | 6.0% PBAT-1 | | | | | | | | | |
| CE-10 | 8.0% PBS-1 | 2.85 | 1.78 | 3.29 | 45.11 | 19.6 | 13 | 91.06 | 8.51 | 7.75 |
| | 1.0% FAB-1 | | | | | | | | | |
| E-1 | 2.0% PBAT-1 | 3.40 | 1.34 | 3.27 | 35.13 | NA | 16 | 86.33 | 6.15 | 6.41 |
| | 6.0% PBS-1 | | | | | | | | | |
| | 1.0% FAB-1 | | | | | | | | | |

The results of the evaluation of the softness of the fibres are shown in Table 3.

TABLE 3

| | Additives | Softness | |
|---|---|---|---|
| # | (% by weight) | rating | Additional comments |
| CE-1 | NA | 2 | stiff |
| CE-2 | 3.0% FAB-2 | 5 | Very soft, feels smooth |
| CE-3 | 10.0% PBS-1 | 3 | bulky / fluffy |
| | 0.2% Erucamide | | |
| CE-4 | 3.0% CM-1 | 2 | stiff |
| CE-5 | 7.0% CM-2 | 3 | Easier to deform |
| CE-6 | 5.0% PBAT-1 | 3 | Easier to deform |
| CE-7 | 2.0% FAB-1 | 5 | Very soft, feels smooth |
| CE-8 | 8.0% PBS-1 | 4 | Smooth and bulky |
| | 2.0% FAB-2 | | |
| CE-9 | 1.0% FAB-1 | 4 | Smooth, easier to deform |
| | 6.0% PBAT-1 | | |
| CE-10 | 8.0% PBS-1 | 4 | Smooth, bulky |
| | 1.0% FAB-1 | | |
| E-1 | 2.0% PBAT-1 | 5 | Smooth, easier to |
| | 6.0% PBS-1 | | deform and bulky |
| | 1.0% FAB-1 | | |

From Tables 2 and 3, it can be seen that when only adding fatty acid bisamide FAB-1 or FAB-2 to PLA-1 (CE-2 and CE-7) the softness of the staple fibres was improved, comparing to neat PLA-1 staple fibres of CE-1. However, CE-2 and CE-7 showed a much inferior tenacity than neat PLA-1 staple fibres (see CE-1). This indicates that only adding fatty acid bisamide into PLA will have detrimental effect to the mechanical strength of the staple fibres. On the other hand, adding a polymer such as PBS-1 with erucamide (CE-3) or only a polymer such as PBAT-1 (CE-6), only slightly improves the softness of the staple fibres.

Surprisingly, it was found that E-1, which contain both first polymer (i.e., PBS-1) and second polymer (i.e., PBAT-1) and the fatty acid bisamide (FAB-1), displayed the highest possible softness rating, while maintaining comparable tenacity as neat PLA staple fibres (CE-1). This is a synergistic effect which could not be achieved by either adding the first and second polymers or the fatty acid bisamide alone.

Furthermore, E-1 also displayed exceptionally high crimp elasticity. Since the crimp elasticity indicates the ability of the staple fibres to recover after deformation, higher crimp elasticity contributes to better bulkiness of the staple fibres, which is also beneficial for the soft hand feeling.

### Preparation of Non-Wovens

### Comparative Example 11 (CE-11)

40.0% by weight of staple fibres as produced in CE-1 and 60.0% by weight of viscose fibres (1.2 D, 38 mm) were first weighed, blended and opened using a staple fibres opener. The mixed fibres were then carded and cross-lapped on a web cross lapping machine. The preformed web was then subjected to a 1^{st} step hydroentanglement with 30 bar water jet, and then 2^{nd} step hydroentanglement with 55.6 bar water jet. Finally, the hydroentangled web was dried under 100° C. to give the spunlace nonwoven.

### Comparative Example 12 (CE-12)

40.0% by weight of staple fibres as produced in CE-9 and 60.0% by weight of viscose fibres (1.2 D, 38 mm) were first weighed, blended and then made into spunlace nonwoven following the same procedure as in CE-11.

### Comparative Example 13 (CE-13)

40.0% by weight of staple fibres as produced in CE-10 and 60.0% by weight of viscose fibres (1.2 D, 38 mm) were first weighed, blended and then made into a spunlace nonwoven following the same procedure as in CE-11.

### Example 2 (E2)

40.0% by weight of staple fibres as produced in E-1 and 60.0% by weight of viscose fibres (1.2 D, 38 mm) were first weighed, blended and then made into a spunlace nonwoven following the same procedure as in CE-11.

The results of the evaluation of the softness of the spunlace non-wovens are shown in Table 4.

TABLE 4
Properties of the spunlace non-wovens

| | Type | | | | Normalised | | Thickness | | |
|---|---|---|---|---|---|---|---|---|---|
| | of | Basis | Softness | | Softness | | (mm) | | |
| | PLA | Weight | (mN) | | (mN/gsm) | | No | Under | Compression |
| # | fibres | (gsm) | MD | TD | MD | TD | pressure | 100 cN | % |
| CE 11 | neat PLA | 92.67 | 84.6 | 77.6 | 0.913 | 0.837 | 0.9730 | 0.7470 | 30.250 |
| CE-12 | 6.0% PBAT-1 | 89.25 | 69.5 | 3.38 | 0.779 | 0.038 | 0.9025 | 0.6625 | 36.225 |
| | PLA | | | | | | | | |
| | 1.0% FAB-1 | | | | | | | | |
| CE-13 | PLA | 80 | 68.6 | 2.63 | 0.858 | 0.033 | 0.9670 | 0.6600 | 46.515 |
| | 8.0% PBS-1 | | | | | | | | |
| | 1.0% FAB-1 | | | | | | | | |
| E-2 | PLA | 81.6 | | | 0.704 | 0.0277 | 0.981 | 0.651 | 50.69 |
| | 6.0% PBS-1 | | | | | | | | |
| | 2.0% PBAT-1 | | | | | | | | |
| | 1.0% FAB-1 | | | | | | | | |

According to the softness measurements, the normalized force required to pull the E-2 nonwoven through the handle-o-meter slit is decreased versus the comparative Examples CE-11, CE-12, CE-13, indicating that the example according to the invention showed a higher softness.

### Comparative Example 14 (CE-14)

100% staple fibres as produced in CE-1 were first weighed and opened using a staple fibres opener. Afterwards the fibres were carded and cross-lapped on a web cross lapping machine. The preformed web was then subjected to heat calendering by a pair of rollers set at the temperature of 138° C. and the linear pressure of 56 kg/cm, giving heat calendered nonwoven.

### Comparative Example 15 (CE-15)

The same procedure as CE-14 was used to produce heat calendered nonwoven with 100% staple fibres as produced in CE-9. However, it was found during the calendering step, the staple fibres became deformed and stiffened, leading to stiff nonwoven product. Increasing the calendering temperature made the problem worse, while decreasing the calendering temperature led to insufficient bonding between the fibres, and the produced nonwoven showed a lack of strength. As a result, no good sample was produced with staple fibres of CE-9.

### Comparative Example 16 (CE-16)

100% staple fibres as produced in CE-10 were used to produce heat calendared nonwoven successfully, following the same procedure as in CE-14.

### Example 3 (E-3)

100% staple fibres as produced in E-1 were used to produce heat calendared nonwoven successfully, following the same procedure as in CE-14.

The results of the evaluation of the softness of the calendered non-wovens are shown in Table 5.

TABLE 5
Properties of the heat calendered non-wovens

| | | Basis | Normalized Softness | |
|---|---|---|---|---|
| | Type of | weight | (mN/gsm) | |
| Sample # | PLA fibres | (gsm) | MD | TD |
| CE-14 | neat PLA | 38 | 9.58 | 3.19 |
| CE-15 | PLA | Not | Not | Not |
| | 6.0% PBAT-1 | produced | produced | produced |
| | 1.0% FAB-1 | | | |
| CE-16 | PLA | 51 | 12.56 | 4.75 |
| | 8.0% PBS-1 | | | |
| | 1.0% FAB-1 | | | |
| E-3 | PLA | 22.6 | 8.66 | 2.36 |
| | 6.0% PBS-1 | | | |
| | 2.0% PBAT-1 | | | |
| | 1.0% FAB-1 | | | |

E-3 demonstrates that the non-wovens according to the invention are softer compared to non-wovens made from neat PLA (CE-14) and also compared to non-wovens CE-16. In addition, the present invention allows overcoming the problems encountered when trying to produce non-wovens according to CE-15.

1. Fibres, comprising a polymer composition, wherein said polymer composition comprises, relative to the total weight of the polymer composition:
from at least 70.0% by weight to at most 97.5% by weight of a polylactide (PLA) polymer;
from at least 1.0% by weight to at most 10.0% by weight of a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
from at least 1.0% by weight to at most 10.0% by weight of a second polymer, selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and
from at least 0.5% by weight to at most 10.0% by weight of a fatty acid bisamide or an alkyl-substituted fatty acid monoamide.

2. Fibres according to claim 1, wherein the first polymer is selected from the group comprising polybutylene succinate (PBS), poly(ethylene succinate) (PES), poly(propylene succinate) (PPS), polybutylene adipate (PBA), polybutylene succinate adipate (PBSA), and polybutylene succinate terephthalate (PBST); preferably PBS.

3. Fibres according to claim 1, wherein the second polymer is selected from the group comprising polybutylene adipate terephthalate (PBAT), polycaprolactone (PCL), and polyhydroxyalkanoates (PHA) and polypropylene carbonate (PPC); preferably PBAT.

4. Fibres according to claim 1, wherein the polymer composition comprises from at least 2.0% by weight to at most 10.0% by weight of the first polymer relative to the total weight of the composition, preferably at least 3.0% by weight to at most 9.0% by weight, preferably at least 4.0% by weight to at most 8.0% by weight, preferably at least 5.0% by weight to at most 7.0% by weight, preferably at least 5.5% by weight to at most 6.5% by weight, of the first polymer.

5. Fibres according to claim 1, wherein the polymer composition comprises from at least 1.0% by weight to at most 7.0% by weight, relative to the total weight of the polymer composition, preferably at least 1.0% by weight to at most 5.0% by weight, preferably at least 1.2% by weight to at most 4.0% by weight, preferably at least 1.5% by weight to at most 3.0% by weight, preferably at least 1.7% by weight to at most 2.5% by weight, of the second polymer.

6. Fibres according to claim 1, wherein the first polymer is poly(butylene succinate) (PBS) and wherein the second polymer is poly(butylene adipate-co-terephthalate) (PBAT).

7. Fibres according to claim 1, wherein the fatty acid bisamide or the alkyl-substituted fatty acid monoamide is selected from the group comprising N,N′-ethylenebis(stearamide), N,N′-methylenebis(caprylamide), N,N′-methylenebis(capramide), N,N′-methylenebis(lauramide), N,N′-methylenebis(myristamide), N,N′-methylenebis(palmitamide), N,N′-methylenebis(stearamide), N,N′-methylenebis(isostearamide), N,N′-methylenebis(behenamide), N,N′-methylenebis(oleamide), N,N′-methylenebis(erucamide), N,N′-ethylenebis(caprylamide), N,N′-ethylenebis(capramide), N,N′-ethylenebis(lauramide), N,N′-ethylenebis(myristamide), N,N′-ethylenebis(palmitamide), N,N′-ethylenebis(isostearamide), N,N′-ethylenebis(behenamide), N,N′-ethylenebis(oleamide), N,N′-ethylenebis(erucamide), N,N′-1,4-butanediylbis(stearamide), N,N′-1,4-butanediylbis(behenamide), N,N′-1,4-butanediylbis(oleamide), N,N′-1,4-butanediylbis(erucamide), N,N′-(1,6-hexanediyl)bis(stearamide), N,N′-(1,6-hexanediyl)bis(behenamide), N,N′-(1,6-hexanediyl)bis(oleamide), N,N′-(1,6-hexanediyl)bis(erucamide), N,N′-[1,3-phenylenebis(methylene)]bis(stearamide), N,N′-[1,3-phenylenebis(methylene)]bis(12-hydroxystearamide), N,N′-[1,4-phenylenebis(methylene)]bis(stearamide), N,N′-[1,4-phenylene]bis(stearamide), N,N′-distearyl amide adipate, N,N′-distearyl amide sebacate, N,N′-dioleyl amide adipate, N,N′-dioleyl amide sebacate, N,N′-distearyl amide isophthalate, N,N′-distearyl amide terephthalate, N,N′-methylenebis(hydroxystearamide), N,N′-ethylenebis(hydroxystearamide), N,N′-1,4-butanediylbis(hydroxystearamide), N,N′-(1,6-hexanediyl)bis(hydroxystearamide), N-lauryl amide laurate, N-palmityl amide palmitate, N-stearyl amid stearate, N-behenyl amide behenate, N-oleyl amid oleate, N-stearyl amid oleate, N-oleyl amid stearate, N-stearyl amid eruciate, N-oleyl amid palmitate, methylol amide stearate, methylol amid behenate, N-stearyl-12-hydroxy amide stearate, N-oleyl 12 hydroxy amide stearate and mixtures thereof, and mixtures thereof;
preferably wherein the fatty acid bisamide is N,N′-ethylenebis(stearamide) (EBS).

8. Fibres according to claim 1, wherein the fibres are staple fibres.

9. A non-woven, comprising the fibres according to claim 1.

10. A blend for use as a softening agent for polylactide (PLA) polymer fibres or for use as a softening agent for polylactide (PLA) polymer non-wovens, wherein the blend comprises:
a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC); wherein said first and second polymers are selected such as not to be the same; and,
a fatty acid bisamide or an alkyl-substituted fatty acid monoamide.

11. (canceled)

12. A process for producing fibres, preferably fibres according to claim 1, comprising the steps of:
a) providing a polymer composition comprising:
from at least 70.0% by weight to at most 97.5% by weight polylactide (PLA) polymer;
from at least 1.0% by weight to at most 10.0% by weight of a first polymer selected from the group comprising polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene adipate terephthalate (PBAT), polybutylene succinate terephthalate (PBST), and polypropylene carbonate (PPC);
from at least 1.0% by weight to at most 10.0% by weight of a second polymer selected from the group comprising polybutylene adipate terephthalate (PBAT), polybutylene succinate (PBS), poly(ethylene succinate) (PES), poly(propylene succinate) (PPS), polybutylene adipate (PBA), polybutylene succinate adipate (PBSA), polycaprolactone (PCL), polyhydroxyalkanoates (PHA), polybutylene succinate terephthalate (PBST), and polypropylene carbonate (PPC), wherein said first and second polymers are selected such as not to be the same; and
from at least 0.5% by weight to at most 10.0% by weight of a fatty acid bisamide or an alkyl-substituted fatty acid monoamide;
b) processing the polymer composition into fibres.

13. A process for producing non-wovens comprising the steps of:
arranging fibres obtained in claim 1 in a web or in two or more cross-lapped webs; and,
consolidating the web(s).

14. An article comprising a non-woven according to claim 9, preferably wherein the article is a garment, a mask, a wipe or a hygiene product.

15. The article according to claim 14, wherein the non-woven is used as a contact layer, dispersion layer or an absorbing layer in the article.
